(19) United States
(12) Patent Application Publication
(10) Pub. No.: US 2022/0099909 A1
(43) Pub. Date: Mar. 31, 2022

(54) PROTECTIVE SHELL FOR PHOTOGRAPHIC EQUIPMENT HAVING REMOVABLE EXTERNAL LENS

(71) Applicant: GUANGDONG SIRUI OPTICAL CO., LTD., ZHONGSHAN (CN)

(72) Inventors: JIE LI, ZHONGSHAN (CN); XIANGYU HUANG, ZHONGSHAN (CN)

(73) Assignee: GUANGDONG SIRUI OPTICAL CO., LTD., ZHONGSHAN (CN)

(21) Appl. No.: 16/478,051

(22) PCT Filed: Jul. 11, 2018
(86) PCT No.: PCT/CN2018/095240

§ 371 Date: Jul. 16, 2019

(30) Foreign Application Priority Data
Jun. 27, 2018 (CN) 201810680830.1

(51) Int. Cl. G02B 7/02; H04B 1/3888; H04M 1/02

(52) U.S. Cl. CPC G02B 7/021; H04M 1/0202; H04B 1/3888; G02B 7/026

(57) ABSTRACT

A protective device protective shell includes a detachable external lens. A lens holder is positioned on the pivot positioning member and coupled to the housing body, and the first elastic member is axially disposed along the pivot positioning member, so that the lens holder only needs to overcome the first positioning portion when rotating around the pivot positioning member. The static friction force between the first mating positioning portions and the biasing force of the first elastic member avoids generating a rotational moment to the first elastic member, thereby preventing the first elastic member from being damaged due to the rotational moment, thereby making the lens holder rotate more smoothly. The sliding is used to greatly extend the service life of the protective casing of the external lens shooting device of aspects of the invention, and the structure thereof is simple, thereby saving production cost.

### TECHNICAL FIELD

Aspects of the invention relates to the technical field of mobile phone accessories, and in particular to a protective device for a photographing equipment having a detachable external lens.

### BACKGROUND

When the mobile phone was first introduced, it was only used as a portable telephone terminal that may be used in a wide range. With the advancement of technology and the development of the economy, mobile phones have become more and more powerful and have become a necessity. At present, mobile phones are classified into smart phones and non-smart phones. Since smart phones have higher frequency, faster running speed, faster processing tasks, and more convenient daily life, the market share of smart phones is now higher. A smart phone is a personal computer, with a separate operating system, independent operating space, and may be installed by users to install software, games, navigation and other third-party service providers, and may be connected to the wireless network through a mobile communication network. The general name for the type of mobile phone.

One of the most basic functions of a smartphone is the shooting function. Nowadays, the camera function of the mobile phone is getting stronger and higher, and the pixel is getting higher and higher. It is gradually replacing the general home camera and becoming the preferred camera tool for the public. However, since the camera function integrated on the mobile phone is limited by the size and weight of the mobile phone during design, it is generally only possible to perform simple shooting. However, this traditional fixed-focus mobile phone lens may not meet people's pursuit of higher quality of life, so there is a mobile phone external lens, people may choose the special lens they need according to the shooting needs, the general special lens includes 2× zoom, 4× Zoom, macro, fisheye, wide angle, etc.

There are various ways to fix the external lens and the mobile phone of the existing mobile phone, and most of them use a rotating positioning structure to rotate the external lens on the mobile phone case. However, its positioning structure is complex, not only costly, but also low consumer experience. Often, because the lens rotation positioning structure is damaged, the external lens and the built-in camera of the mobile phone maynot be accurately positioned, resulting in the failure of the entire external lens device to be used. Waste of resources.

For example, Chinese Patent Publication No. CN204465641U discloses a multi-lens turntable mobile phone case, which is provided with a turntable on the mobile phone case and a plurality of lenses on the turntable, thereby realizing the lens switching by rotating the turntable when using the mobile phone case. Operation. The connection mode of the turntable on the mobile phone case is as follows: the turntable has an irregular groove on the side close to the cover of the mobile phone case, and a set of circular arc-shaped grooves are formed on the edge of the groove, the number and position of the circular groove and the optical lens The number and location correspond. A telescopic positioning rod is fixed on the fixing hole of the side of the mobile phone casing near the turntable. The length of the telescopic rod is smaller than the length of the outer casing, and the spring is disposed between the bottom of the telescopic rod and the inner surface of the bottom of the outer casing.

However, in the above patent, when the turntable is rotated, the main body of the telescopic positioning rod does not move, but still has to withstand the rotational moment generated when the turntable rotates. Therefore, often after a period of use, the telescopic positioning rod starts to loosen, resulting in unsatisfactory rotation and normal positioning.

### SUMMARY

Therefore, the technical problem to be solved by aspects of the invention is to overcome the defects that the external lens of the mobile phone in the prior art has a complicated and easy damage to the positioning structure of the mobile phone, which affects the service life of the external lens, thereby providing a simple structure, long service life, and Remove the protective device cover of the external lens.

In order to solve the above technical problem, a protective device protective cover having a detachable external lens includes a shell body having a built-in camera position hole of a photographing equipment, and an external lens set, wherein the external lens set includes:

a lens holder having a first stepped opening thereon, and a plurality of optical lenses disposed around the first stepped opening;

a pivoting positioning component is respectively provided with a first retaining structure and a second retaining structure at two ends thereof, and a rotating positioning portion is disposed in a middle portion, wherein the rotating positioning portion is located in the first stepped opening, and the first retaining structure and The second retaining structure is respectively located at two ends of the first stepped opening, and the lens holder is positioned on the rotating positioning portion, and the second retaining structure is connected to the shell body;

a first elastic member disposed between the first retaining structure and the step of the first stepped opening, the biasing force acting on the lens holder;

The first positioning structure includes a first positioning portion and a plurality of first positioning and matching portions, and the first positioning portion and the first positioning and engaging portion are disposed on the lens holder and the housing body, or are disposed at the Over the lens holder and the second retaining structure, the lens holder overcomes the movement when the lens holder is moved away from the housing body in the axial direction of the pivot positioning member under an external force An elastic force of an elastic member, the first positioning portion is disengaged from the corresponding first matching positioning portion, and the lens holder is rotatable relative to the housing body under an external force; when the lens holder is rotated to be selected When the optical lens is aligned with the built-in camera position hole and the external force is lost, the lens holder is caused by the elastic force of the first elastic member to make the first positioning portion and the corresponding first matching positioning portion The lens assembly is positioned on the housing body by alignment.

In the protective device protective shell with the detachable external lens of aspects of the invention, the external lens set further includes a lens cover, the lens cover has a second stepped opening extending toward the inner side of the lens cover, the second The stepped opening is disposed in the first stepped opening of the lens holder, and the rotation positioning portion is located in the second stepped opening, and the first elastic member is disposed on the first retaining structure and the second step Between the steps of the hole.

In the protective shell of the photographing equipment with the detachable external lens of aspects of the invention, the first positioning portion is a positioning protrusion, and the first mating positioning portion is a positioning hole adapted to be coupled with the positioning protrusion.

In the casing of the photographing equipment having the detachable external lens of aspects of the invention, the external lens head group is detachably coupled to the casing body.

In the protective device of the photographing equipment with the detachable external lens of aspects of the invention, the shell body is provided with a sliding slot, the two sides of the sliding slot are provided with a guide rail; and the second retaining structure of the pivoting positioning component The trough may be loaded or unloaded from one end of the slot and reciprocated along the sliding rail, and the pivoting positioning element is provided with a mounting groove along the axial direction; the second positioning structure is disposed at the two retaining structures and the slot include an elastic positioning component disposed in the mounting slot, and at least one second mating positioning portion disposed on the bottom of the slot, the elastic positioning component The second positioning portion includes a second elastic portion, and the second positioning portion partially protrudes from the mounting groove and the corresponding second matching positioning portion under the elastic force of the second elastic member to block the second retaining structure moves within the slot.

In the protective device protective casing of aspects of the invention having a detachable external lens, the pivot positioning member includes: a slider, the slider forming the second retaining structure, which may be mounted from one end of the slot Entering or disengaging in the sliding slot and moving along the sliding rail, the slider is provided with a slider through opening; the lens housing shaft, the main body of the lens constitutes the rotating positioning portion, and the first of the lens housing shaft The end is fixedly connected to the slider, and the flange is disposed on the second end thereof to form a first anti-drop structure, and the first end of the lens seat shaft is provided with a blind hole, the blind hole and the sliding The block through openings communicate to form the mounting groove.

In the protective device casing of the photographing equipment with the detachable external lens of aspects of the invention, the second elastic member is a spring, the second positioning portion is a ball, and the second mating positioning portion is disposed in the sliding slot Limit groove on the bottom.

In the protective casing of the photographing equipment having the detachable external lens of aspects of the invention, the diameter of the slider through opening is smaller than the diameter of the ball.

In the protective device of the photographing equipment with the detachable external lens of aspects of the invention, the limiting recess is provided with two, including a first limiting recess when the external lens group is in the shooting position, and when externally positioned The second limit groove when the camera group is in the non-photographing position.

In the protective device casing of the photographing equipment having the detachable external lens of aspects of the invention, the first positioning portion is disposed on the slider, and the first mating positioning portion is disposed on the lens holder.

In the protective shell of the photographing equipment with the detachable external lens of aspects of the invention, one of the guide rail and the slider is provided with a limiting protrusion, and the other of the two is provided with the limit The convex shape matches the groove, and the slider is embedded from the groove by the limiting protrusion, so that the limiting protrusion is combined with the guide rail and slides along the guide rail. In the protective device of the photographing equipment with the detachable external lens of aspects of the invention.

The strip has a strip shape, and the upper and lower edges each have the limiting protrusion; the slot has an elongated shape, and the upper and lower edges have the groove matching the shape of the limiting protrusion.

In the protective device casing of aspects of the invention having a detachable external lens, the casing body is a composite structure including a soft shell suitable for wrapping the frame of the photographing equipment and a hard shell suitable for positioning the external lens group. a first position opening is formed on the soft shell, and a second position opening is formed on the hard shell, and the built-in camera position hole is composed of the first position opening and the second position opening. The slot is formed on the hard shell.

In the protective shell of the photographing equipment with the detachable external lens of aspects of the invention, the position of the soft shell corresponding to the slot is further provided with a strip hole communicating with the first position opening.

In the protective device casing of the photographing equipment with the detachable external lens of aspects of the invention, the photographing equipment soft shell and the photographing equipment shell are hard-adhesively bonded and positioned.

In the protective shell of the photographing equipment having the detachable external lens of aspects of the invention, the shell body is of a unitary structure.

In the protective shell of the photographing equipment with the detachable external lens of aspects of the invention, the slider is provided with a shaft seat, and the lens seat shaft is placed in the seat slot of the shaft seat.

In the protective shell of the photographing equipment with the detachable external lens of aspects of the invention, the seat groove of the shaft seat is circular, and a positioning plane is arranged along the axial direction of the seat groove; A positioning table that matches the positioning plane in the housing.

In the protective casing of the photographing equipment having the detachable external lens of aspects of the invention, the photographing equipment is a mobile phone.

In the protective shell of the photographing equipment with the detachable external lens of aspects of the invention, the first mating positioning portion and the optical lens group are provided in the same number, and the optical lens group is three groups.

Three should be provided for the first matching positioning portion.

In aspects of the invention, the lens seat shaft and the slider are screwed.

In aspects of the invention, the first stepped opening and the second stepped opening are respectively disposed at the center positions of the lens holder and the lens cover.

In aspects of the invention, the first elastic member employs a return spring. The technical solution of aspects of the invention has the following advantages:

1. In aspects of the invention, the lens holder is positioned on the pivot positioning member to be coupled to the housing body, and the first elastic member is axially disposed along the pivot positioning member such that the lens holder rotates about the pivot positioning member. It is only necessary to overcome the static friction between the first positioning portion and the first positioning engagement portion and the biasing force of the first elastic member, thereby avoiding generating a rotational moment to the first elastic member and preventing the first elastic member from occurring due to the rotational moment. The damage is made, so that the rotation of the lens holder is smoother, so that the service life of the protective casing using the external lens shooting device of aspects of the invention is greatly extended, and the structure is simple, thereby saving production cost and increasing market share.

2. In aspects of the invention, the lens cover is added to protect the optical lens in the lens holder from being in an unused state. The lens cover is positioned by providing a second stepped opening extending inwardly at the center of the lens cover, the second stepped opening is placed in the first stepped opening of the lens holder, and the first elastic member is placed in the second stepped opening and Between the first retaining structures of the pivot positioning members, the lens holder is firmly positioned on the pivot positioning member, and the mounting structure is simple and not easily damaged.

3. In aspects of the invention, the external lens may also be detachably connected to the shell body, in particular, by providing the second retaining structure in the pivot positioning member as a slider, and opening a corresponding belt on the shell body. There is a sliding groove of the guide rail, and a dislocation limiting mechanism is arranged between the sliding block and the sliding slot, and a second positioning structure is arranged, so that the sliding block may slide freely along the sliding groove on the shell body and accurately position the lens holder. When the external lens is not in use, the position of the built-in camera of the mobile phone may be opened and positioned, or the position of the built-in camera of the mobile phone may be accurately positioned when the external lens is in use. Easy to disassemble and install the external lens.

4. In aspects of the invention, the pivoting positioning element is a non-rotating central positioning element. When the lens seat shaft in the pivoting positioning element is connected with the slider, the special-shaped limit structure is adopted, that is, the lens seat shaft and the slide shaft

A matching axial plane is arranged on the bearing surface of the shaft seat on the block, and the limiting head seat shaft is a non-rotating center positioning axis. The first elastic member disposed inside the lens seat shaft is further protected, and the axial rotation torque is not generated and is damaged.

In aspects of the invention, the external lens may be pushed left and right by the sliding groove and the guide rail on the protective cover of the mobile phone, and the lens holder may be rotated 360 degrees freely, thereby achieving the purpose of interchangeable lenses. The lens holder has two positioning points on the slide rail to facilitate switching the lens holder in the used or non-use position. The same lens seat also has a positioning point for 360-degree rotation to accurately position the position of each group of lenses and the position of the camera built-in camera.

### BRIEF DESCRIPTION OF THE DRAWINGS

In order to more clearly illustrate the specific embodiments of aspects of the invention or the technical solutions in the prior art, the drawings used in the specific embodiments or the description of the prior art will be briefly described below, and obviously, the attached in the following description The drawings are some embodiments of aspects of the invention, and those skilled in the art may obtain other drawings based on these drawings without any creative work.

FIG. 1 is an exploded view of a protective casing of a photographing equipment having a detachable external lens of aspects of the invention;

FIG. 2 is a front elevated view of the protective casing of the photographing equipment with the detachable external lens of aspects of the invention.

FIG. 3 is a cross-sectional view taken along line A-A of FIG. 2.

### DETAILED DESCRIPTION

### Description of the Reference Numbers

11—soft shell; 111—first position opening; 112—bar opening; 12—hard shell; 121—second position opening; 122—slot; 123—groove; 124—first limiting groove; 125—second limiting groove; 21—lens holder; 211—first stepped opening; 211a—step; 22—first elastic member; 23—lens seat shaft; 231—flange; 232—blind hole; 24—lens cover; 241—second stepped opening; 3—slider; 31—limiting protrusion; 32—slider through opening; 33—positioning projection; 34—ball; 35—spring.

The technical solutions of aspects of the invention will be clearly and completely described in the following with reference to the accompanying drawings. It is obvious that the described embodiments are a part of the embodiments of aspects of the invention, and not all of the embodiments. All other embodiments obtained by those skilled in the art based on the embodiments of aspects of the invention without creative efforts are within the scope of aspects of the invention. In the description of aspects of the invention, it should be noted that the terms “center”, “upper”, “lower”, “left”,

The orientation or positional relationship of the indications of “right”, “vertical”, “horizontal”, “inside”, “outside”, etc. is based on the orientation or positional relationship shown in the drawings, for convenience of description of aspects of the invention and simplified description. Instead of indicating or implying that the device or component referred to must have a particular orientation, constructed and operated in a particular orientation, it is not to be construed as limiting aspects of the invention. Moreover, the terms “first,” “second,” and “third” are used for descriptive purposes only and are not to be construed as indicating or implying relative importance.

In the description of aspects of the invention, it should be noted that the terms “installation”, “connected”, and “connected” are to be understood broadly, and may be fixed or detachable, for example, unless otherwise explicitly defined and defined. Connection, or integral connection; may be mechanical connection or electrical connection; may be directly connected, or may be indirectly connected through an intermediate medium, and may be internal communication between the two elements. The specific meaning of the above terms in aspects of the invention may be understood in a specific case by those skilled in the art.

Further, the technical features involved in the different embodiments of aspects of the invention described below may be combined with each other as long as they do not constitute a conflict therebetween.

### Example 1

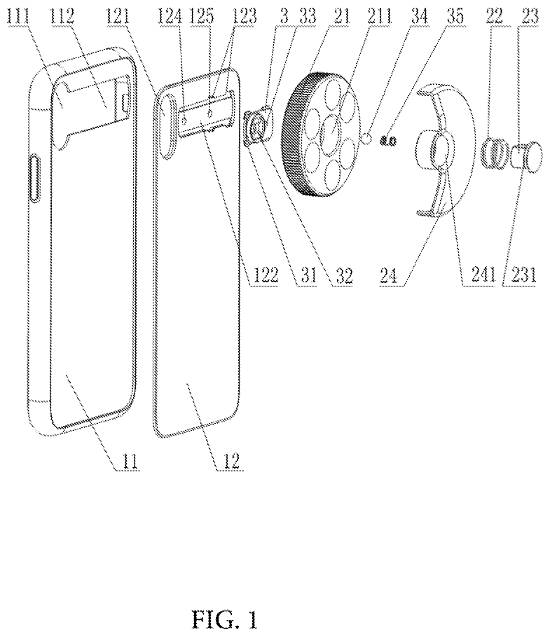

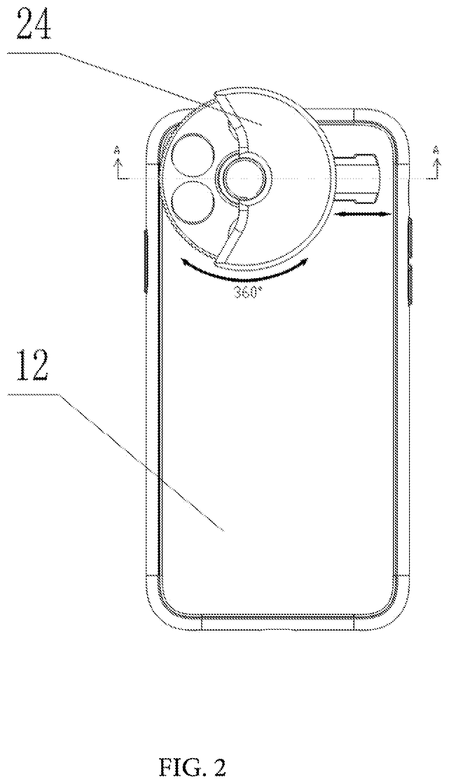

As shown in FIGS. 1-3, a protective device shell of a photographing equipment having a detachable external lens includes a shell body having a built-in camera position hole of a photographing equipment, and an external lens group, the external lens group includes:

a lens holder 21 having a first stepped opening 211 thereon and a plurality of optical lenses disposed around the first stepped opening 211;

a pivoting positioning component is respectively provided with a first retaining structure and a second retaining structure at both ends, and a rotating positioning portion is disposed at a middle portion thereof, wherein the rotating positioning portion is located in the first stepped opening 211, and the first retaining structure and the second retaining structure are respectively located at two ends of the first stepped opening 211, and the lens holder 21 is disposed at the rotation positioning portion, and the second retaining structure is connected to the shell body;

a first elastic member 22 is disposed between the first retaining structure and the step of the first stepped opening 211, and a biasing force acts on the lens holder 21; the first positioning structure includes a first positioning portion and a plurality of first mating positioning portions, the first positioning portion and the first mating positioning portion are disposed on the lens holder 21, the shell body, or on the lens holder 21, the second retaining structure, the lens holder 21 overcomes the elastic force of the first elastic member 22 when moving away from the housing body in the axial direction of the pivot positioning member under an external force. The first positioning portion is disengaged from the corresponding first matching positioning portion, and the lens holder 21 is rotatable relative to the housing body under an external force; when the lens holder 21 is rotated to the selected optical body when the lens is aligned with the position of the built-in camera and the external force is lost, the lens holder 21 aligns the first positioning portion with the corresponding first matching positioning portion under the elastic force of the first elastic member 22 to limit the lens holder 21 to the shell body.

The above solution may include a core solution of aspects of the invention. The lens holder 21 is positioned on the pivot positioning member to be coupled to the housing body, and the first elastic member 22 is axially disposed along the pivot positioning member, so that the lens holder 21 is pivotally positioned. When the component is rotated centrally, it is only necessary to overcome the static friction between the first positioning portion and the first positioning engagement portion and the biasing force of the first elastic member 22, thereby avoiding generating a rotational moment to the first elastic member and avoiding the first elastic member. Damaged by the action of the rotating torque, so that the lens holder 21 rotates more smoothly, so that the service life of the protective casing using the external lens shooting device of aspects of the invention is greatly extended, and the structure is simple, thereby saving production cost and improving the market.

In aspects of the invention, the photographing equipment is a mobile phone. In aspects of the invention, the pivot positioning component includes three parts, respectively, a rotation positioning portion that is a central rotation of the limiting lens holder, a first retaining structure and a second anti-drop structure respectively located at upper and lower ends of the rotation positioning portion. The first retaining structure and the second retaining structure are used to prevent the lens holder from coming out of the rotational positioning portion. Specifically, in the present embodiment, the pivot positioning member employs a lens seat shaft 23, wherein the first end of the lens seat shaft 23 is provided with a flange 231 as a first retaining structure, and a middle portion is a rotational positioning portion. A shaft seat is disposed on the upper end surface of the second retaining structure for placing the second end of the lens seat shaft 23.

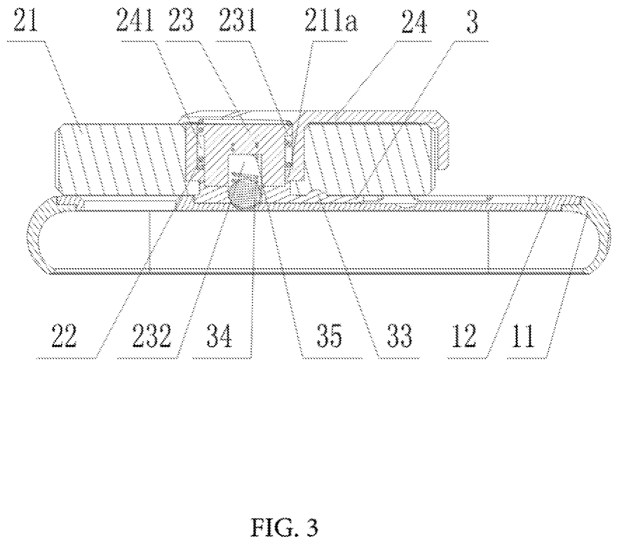

The middle limit is fixed to the second retaining structure and the lens seat shaft 23 by screws. The length of the shaft seat on the second retaining structure in the vertical direction and the length of the lens seat shaft 23 are adjusted according to actual needs. In this embodiment, referring to FIG. 3, the length of the lens seat shaft 23 is greater than the length of the shaft seat. This facilitates subsequent installation of the second positioning portion. In the embodiment, the pivoting positioning component has a simple structure and is convenient to install. As a variant embodiment, the pivot positioning member may also be formed by a screw, the nut as the first anti-drop structure, the screw as the rotation positioning portion, and the second retaining structure may be screwed.

In aspects of the invention, the second retaining structure may adopt a long strip, a circular plate or a special-shaped plate having a larger size than the first stepped opening 211 in the lens holder 21, and the plate is provided with a lens seat shaft 23 connected thereto.

In aspects of the invention, the first positioning portion is a positioning protrusion 33 disposed on the second retaining structure, the first engaging positioning portion is a positioning hole provided on the lens holder 21, and the positioning hole is a blind hole. When the lens holder 21 is moved away from the housing body in the axial direction of the lens seat shaft 23 by an external force, the elastic force of the first elastic member 22 is overcome, and the positioning protrusion 33 and the corresponding the positioning hole is disengaged, and the lens holder 21 rotates relative to the housing body and the lens seat shaft 23 by an external force; when the lens holder 21 is rotated until the selected optical lens is aligned with the position of the built-in camera, the external force disappears. The lens holder 21 is aligned with the corresponding positioning hole by the elastic force of the first elastic member 22, that is, the positioning protrusion 33 slides into the positioning hole, and the lens holder 21 is limited to the housing body. on. In addition, in the embodiment, the lens holder 21 is provided with three sets of optical lenses. Correspondingly, the positioning holes on the lens holder 21 are also provided with three positioning holes for positioning the three sets of optical lenses and the built-in camera of the mobile phone. Referring to FIG. 1, it may be seen that the present embodiment includes three sets of optical lenses, each of which includes two separate optical lenses.

In aspects of the invention, a lens cover 24 is further provided in the external lens group, and the lens cover 24 has a second stepped opening 241 extending toward the inner side of the lens cover 24, and the second stepped opening 241 is placed in the mirror.

The first stepped opening 211 of the lens holder 21 is prevented from being disengaged, the rotational positioning portion of the lens seat shaft 23 is located in the second stepped opening 241, and the first elastic member 22 is disposed on the first retaining structure and between the step 211a of the second stepped opening 241. Adding the lens cover 24 protects the optical lens in the lens holder 23 that is not in use. The lens cover 24 is positioned by providing a second stepped opening 241 extending inwardly in the center of the lens cover 24, the second stepped opening 241 is placed in the first stepped opening 211 of the lens holder 21, and the first elastic member 22 is disposed. The second stepped opening 241 is disposed between the first retaining structure of the pivot positioning member, so that the lens holder 21 is firmly positioned on the pivot positioning member, and the mounting structure is simple and not easily damaged. As a modified embodiment, in aspects of the invention, the first elastic member 22 may be directly fitted on the lens seat shaft 23 by using a larger-sized return compression spring, or a plurality of small-sized return springs may be uniformly disposed around the lens holder 23. In aspects of the invention, the external lens set is also detachably coupled to the housing body. The specific setting structure is: firstly, the second retaining structure is set as the slider 3, the slider 3 is a long strip of a general rule, and four limit protrusions 31 are distributed on the upper and lower edges; a slot 122, two sides of the slot 122 are provided with a guide rail, the slot 122 is elongated, and the upper and lower edges have four grooves 123 matching the shape of the limiting protrusion 31; The slider 3 may be loaded into or out of the slot 122 from one end of the slot 122 and reciprocated along the slide rail. The upper end surface of the slider 3 is provided with a shaft seat, the lens seat shaft 23 is placed in the limit of the shaft seat, and four screw mounting holes are arranged in the shaft seat, and the first end of the lens seat shaft 23 is also provided with four threaded holes. The two are fixed by means of screws. The first end of the lens seat shaft 23 is provided with a blind hole 232 in the axial direction, and the slider 3 is provided with a slider through opening 32, and the blind hole 232 communicates with the slider through opening 32 to form a mounting groove; In the mounting groove, a spring 35 is disposed as a second elastic member, and a ball 34 is mounted at the end of the spring 35 as a second positioning portion, and correspondingly, two limiting grooves are disposed on the bottom of the groove of the sliding groove 122 as a second matching positioning portion, wherein The first limiting groove 124 is used for limiting when the external lens group is in the shooting position, and the second limiting groove 125 is used for limiting when the external lens group is in the non-photographing position. Further, the diameter of the slider through opening 32 is smaller than the diameter of the ball 34 to prevent the ball 34 from coming out of the slider through opening 32. As a variant embodiment, the balls 34 may also be replaced by spring pins or hemispherical rounded projections; the springs 35 may also be arranged in a mounting groove by a plurality of sets of small-sized compression springs.

In aspects of the invention, the casing body is a composite structure comprising a soft shell 11 adapted to wrap the frame of the photographing equipment and a hard shell 12 adapted to position the external lens pack, both of which are bonded and positioned. The soft shell 11 is formed with a first position opening 111, and the hard shell 12 is formed with a second position opening 121. The built-in camera position hole is formed by the first position opening 111 and the second position. The holes 121 are overlapped, and the slot 122 is formed on the hard shell 12. A strip hole 112 communicating with the first position opening 111 is further disposed on the soft shell 11 at a position corresponding to the sliding groove 122.

In aspects of the invention, the seat groove of the shaft seat on the slider 3 is circular, and a positioning plane is arranged along the axial direction of the seat groove; the lens seat shaft 23 is axially disposed to fit in the seat groove. Positioning planes match the positioning table. The lens seat shaft 23 and the slider 3 may be rotated without relative rotation by the positioning table provided therebetween.

In the specific implementation, referring to FIG. 1-3, when the external lens needs to be connected to the body of the mobile phone case, the slider 3 is placed at the rightmost end of the housing body slot 122, and the slider 3 is

The limiting protrusions 31 on the four corners are aligned with the four grooves 123 on the sliding slot 122. At this time, the four limiting protrusions 31 of the slider fall into the guide rails at the upper and lower ends of the sliding slot 122, to the left. Pushing and pulling the external lens limits the slider 3 in the guide rail. At this time, the ball 34 is not protruded in the through opening 32 of the slider, and the spring 35 is in a strong compression state in the blind hole 232; the external push is continued to the left. When the ball 34 and the second limiting groove 125 are coincident with each other, the ball 34 partially protrudes from the slider through opening 32 and falls into the second limiting groove 125 to limit the position of the slider 3 and the sliding slot 122. Relatively fixed, at this time, the external lens is in the non-photographing position. When an external lens is required for shooting, the external lens applies a certain pulling force to the left, and the ball 34 is pulled out from the second limiting groove 125 by the pushing force and retracted into the slider through opening 32, and continues to When the ball 34 is overlapped with the first limiting groove 124, the ball 34 partially protrudes from the slider through opening 32 and falls into the first limiting groove 124, and the slider 3 and the sliding slot 122 The position is relatively fixed, at this time, the external lens is in the shooting position.

When the desired optical lens group is selected, a certain rotational force is applied to the lens holder 21, and the lens holder 21 is rotated by the second stepped opening of the lens cover 24, and the positioning hole on the lens holder 21 gradually becomes on the slider 3. The positioning protrusion 33 is disengaged, and the lens holder 21 drives the lens cover 24 to move away from the housing body along the axial direction of the lens housing shaft 23; continue to rotate the lens holder 21, when the next positioning hole on the lens holder 21 and the slider 3 When the positioning protrusions 33 are aligned, the positioning holes are aligned with the positioning protrusions 33 by the first elastic members 22, that is, the return springs, so that the optical lens group is selected and positioned.

In this embodiment, the lens cover 24 is rotatable, and may also be fixedly connected to the shaft seat on the slider 3 through the step 211a of the second stepped opening.

### Example 2

The second embodiment is different from the embodiment 1 in that the shell body is a unitary structure. Obviously, the above embodiments are merely examples for the sake of clarity, but not for the implementation.

The definition of the formula. Other variations or modifications of the various forms may be made by those skilled in the art in light of the above description. There is no need and no way to exhaust all of the implementations. Obvious changes or variations resulting therefrom are still within the protection of aspects of the invention.

1: A protective shell for a camera with a detachable external lens of a photographic equipment comprising:
a shell body having a built-in camera position hole, comprising:
an external lens group, the external lens group comprising:
a lens holder (21) having a first stepped opening (211) thereon and a plurality of first stepped openings (211) an optical lens;
a pivot positioning member having a first retaining structure and a second retaining structure at both ends thereof, a rotating position portion in a middle portion thereof, wherein the rotating positioning portion is disposed at the first stepped opening (211), and the first retaining structure and the second retaining structure are respectively located at two ends of the first stepped opening (211), and the lens holder is (21) limiting on the rotating positioning portion;
a first elastic member (22) is disposed between the first retaining structure and the step of the first stepped opening (211), and a biasing force acts on the lens holder (21); and
a first positioning structure includes a first positioning portion and a plurality of first positioning engagement portions, the first positioning portion and a first positioning engagement portion are disposed on the lens holder (21), the shell body, or on both the lens holder (21) and the second retaining structure, the lens holder (21) is moved away from the shell body in an axial direction of the pivot positioning member by an external force When the body moves, against the elastic force of the first elastic member (22), the first positioning portion is disengaged from the corresponding first matching positioning portion, and the lens holder (21) is opposite to the external force. The housing body rotates; when the lens holder (21) rotates until the selected optical lens is aligned with the built-in camera position hole and the external force disappears, the lens holder (21) is in the first elastic member under an elastic force of 22, the first positioning portion is aligned with a corresponding first matching positioning portion, and the lens holder (21) is restrained on the shell body.

2: The protective shell according to claim 1, wherein the external lens set further comprising a lens cover (24), the lens cover (24) has a second stepped opening (241) extending inside the lens cover (24), the second stepped opening (241) being placed in the first stepped opening (211) of the lens holder (21) for preventing the positional deviation, the rotational positioning The portion is located in the second stepped opening (241), and the first elastic member (22) is disposed between the first retaining structure and the step (211a) of the second stepped opening (241).

3: The protective shell according to claim 1, wherein the first positioning portion is a positioning protrusion (33), and the first matching positioning portion is suitable for Positioning holes for positioning the projections.

4: The protective shell according to any one of claims 1 to 3, wherein the external lens group is detachably coupled to the shell body.

5: The protective shell according to claim 4, wherein the shell body is provided with a slot (122), and two sides of the slot (122) are provided with a guide rail; the second retaining structure of the pivoting positioning component may be from one end of the slot (122) Loading or unloading into the slot (122), and reciprocating along the sliding rail, and the pivot positioning member is provided with a mounting groove along the axial direction; the second positioning structure is disposed on the second retaining structure and Above the chute (122), comprising an elastic positioning component disposed in the mounting slot, and at least one second mating positioning portion disposed on the slot bottom of the slot (122), the elastic positioning The assembly includes a second positioning portion, and a second elastic portion that partially protrudes from the mounting groove and the corresponding second matching positioning portion under the elastic force of the second elastic member The second retaining structure moves within the chute.

6: The protective shell according to claim 5, wherein the pivot positioning member comprises:
a slider (3), the slider (3) constituting the second retaining structure, which may be loaded into or out of the slot (122) from one end of the slot (122), and along the Moving the slide rail, the slider (3) is provided with a slider through opening (32);
a lens holder shaft (23), the main body of which constitutes the rotation positioning portion, the first end of the lens holder shaft (23) is fixedly connected to the slider (3), and the flange is provided on the second end thereof (231) constituting a first retaining structure, the first end of the lens holder shaft (23) is provided with a blind hole (232), and the blind hole (232) is connected with the slider through opening (32) The mounting groove.

7: The protective shell according to claim 6, wherein the second elastic member comprises a spring (35), and the second positioning portion comprises a ball (34); wherein the second mating positioning portion is a limiting recess disposed on a bottom of the slot (122).

8: The protective shell according to claim 7, further comprising two limiting grooves: a first limiting groove (124) disposed when the external lens group is in the photographing position and a second limiting groove (125) when the external lens group is in the non-photographing position.

9: The protective shell according to claim 6, wherein the first positioning portion is disposed on the slider (3), and the first mating positioning portion is disposed at the On the lens holder (21).

10: The protective shell according to claim 6, wherein one of the guide rail and the slider (3) is provided with a limiting protrusion (31), a groove (123) is provided matching the limiting protrusion (31), wherein the slider (3) passes through the limiting protrusion (31) to engage the groove (123) such that the limiting projection (31) is coupled to the guide rail for sliding along the guide rail.

11: The protective shell according to claim 10, wherein the slider (3) has an elongated shape, and the upper and lower edges each have the limiting protrusion (31); and wherein the slot (122) has an elongated shape, and the upper and lower edges have the groove (123) matching the shape of the limiting protrusion (31).

12: The protective shell according to claim 5, wherein the shell body is a composite structure comprising a soft shell (11) adapted to wrap a frame of the photographing equipment and The hard shell (12) of the external lens group is positioned, the soft shell (11) is formed with a first position opening (111), and the hard shell (12) is formed with a second position opening (121). The built-in camera position hole is composed of the first position opening (111) and the second position opening (121), and the slot (122) is formed on the hard shell (12).

13: The protective shell according to claim 12, wherein a position of the soft shell (11) corresponding to the slot (122) is further provided with A strip hole (112) through which the first position opening (111) communicates.

14: The protective shell according to claim 12, wherein the photographing equipment soft shell (11) and the photographing equipment hard shell (12) are adhesively positioned and connected.

15: The protective shell according to claim 1, wherein the shell body is of a unitary structure.

16: The protective shell according to claim 6, wherein the slider (3) is provided with a lens seat, wherein the lens seat shaft (23) disposed at the lens seat.

17: The protective shell according to claim 16, wherein the lens seat includes a seat groove having a circular shape, wherein the seat groove includes a positioning plane arranged along an axial direction of the seat groove; wherein the lens seat shaft (23) is provided in an axial direction with a positioning table adapted to match the positioning plane in the seat groove.

18: The protective shell according to claim 1, wherein the photographing equipment is a mobile phone.
